(19) United States
(12) Patent Application Publication
(10) Pub. No.: US 2016/0368074 A1
(43) Pub. Date: Dec. 22, 2016

(54) WELDING METHOD AND WELDING STRUCTURE OF METAL MEMBERS

(71) Applicant: MAZDA MOTOR CORPORATION, Hiroshima (JP)

(72) Inventors: Masaaki TANAKA, Hiroshima-city (JP); Takashi OGAWA, Hiroshima-city (JP); Masanobu ISHII, Takatsuki-city (JP); Yoshifumi YOSHIDA, Osaka-city (JP)

(73) Assignee: MAZDA MOTOR CORPORATION, Hiroshima (JP)

(21) Appl. No.: 15/180,224

(22) Filed: Jun. 13, 2016

(30) Foreign Application Priority Data
Jun. 22, 2015 (JP) 2015-124528

(51) Int. Cl. B23K 9/00; B23K 9/007; B23K 9/02

(52) U.S. Cl. CPC B23K 9/0026; B23K 9/0213; B23K 9/007

(57) ABSTRACT

There are provided a first step of bending adjacent portions of first and second metal members in the same direction and forming a flange overlapping part where respective flange portions of the first and second metal members are overlapped and contact each other, a second step of starting to perform arc welding from a tip of the flange overlapping part, and a third step of continuing to perform the arc welding until molten metal of a core wire and a base material reaches an opposite-side face of the flange overlapping part and zinc gas generated is emitted from a side opposite to an arc-welding performance side of the flange overlapping part.

### BACKGROUND OF THE INVENTION

The present invention relates to a welding method and a welding structure of metal members, in which first and second metal members which are made of a galvanized steel sheet, respectively, and positioned adjacent to each other are welded by arc welding.

In general, a galvanized steel sheet is used for vehicle components, such as a suspension cross member, a lower arm, an upper arm, or a damper, home electric appliances, such as an air-conditioner case, or building materials for the purpose of rust prevention.

In a case in which the two members made of the galvanized steel sheet are joined together by the arc welding, the zinc added on a surface of the steel sheet is made to evaporate by an arc heat before the steel sheet is molten. That is, since a boiling point 906° C. of the zinc iron is lower than a melting point 1539±3° C. of the iron, the zinc evaporates before the steel sheet melts and then zinc gas comes into molten metal of a core wire, such as a wire, and a base material (steel), so that blowholes and pits (the 4^{th} chapter: welding incomplete portion; JIS Z 3001-4 Welding Terminology) are generated.

When the blowholes and the pits are generated, the strength or the rigidity of the welding of the two members decrease because of welding defects, so that there is a concern about the reliability in a case in which an external force is added. In particular, in a case in which a structure having a closed cross section is formed by using the two members, this problem becomes obvious.

While it can be considered that a unique wire or a special arc-welding device are used in order to suppress of generation of the blowholes and pits, it is requested to suppress the generation of the blowholes and pits without using such a unique wire or a special welding device.

Herein, International Publication No. WO 2005/029611 A1 discloses, as shown in FIG. 4, a technology that in a case in which two members 81, 82 are assembled and thereby a closed cross-section structure 83 (a battery case) is formed, a flange portion 81a provided at one of those 81 and a flange portion 82a provided at the other member 82 are made to contact each other and an outer end face of the flange members 81a, 82a is welded by micro-arc welding.

In the conventional technology disclosed in the above-described patent document, the arc welding is simply performed from a tip where the two flange portions 81a, 82a are overlapped and thereby an inside of a closed cross section 84 can be sealed up. While this patent document discloses nothing about a specific material of the two members 81, 82, the zinc gas generated during the arch welding stays inside the molten metal when the two members are made of a galvanized steel sheet, so that there is a problem that the generation of the blowholes and pits may not be able to be suppressed when the welding is performed.

Further, Japanese Patent Laid-Open Publication No. 2003-169772 discloses, as shown in FIG. 5, another technology that in a case in which a stainless-made top plate 91 and a stainless-made body panel 92 are assembled to form a dish-washer case 93, there are provided a flange portion 91a which is integrally formed by bending part of the top panel 91 downward and a flange portion 92a which is integrally formed by bending part of a top portion of the body panel 92 downward, and the both flange portions 91a, 92a are made to contact each other and an argon arc welding (also called inert gas arc welding, which is a welding method in which an arc is generated in inert gas) is performed for a tip of an overlapping part of the flange portions 91a, 92a where the flange portions 91a, 92a are overlapped, thereby forming a welded portion 94.

In the present patent document, in a case in which the material of the top panel 91 and the body panel 92 is changed from the stainless to the galvanized steel sheet, the zinc gas generated during the arch welding stays inside the molten metal as described above, so that there is the similar problem that the generation of the blowholes and pits may not be able to be suppressed at the welded portion 94. Further, the conventional technology disclosed in the above-described Japanese patent document relates to a so-called edge weld (a plate is bent in a flange shape and its end face is welded), which does not suggest any technical ideas of the present invention.

### SUMMARY OF THE INVENTION

An object of the present invention is to provide a welding method and a welding structure of metal members which can properly prevent the zinc gas generated during the arch welding from staying inside the molten metal of the core wire and the base material (steel sheet), thereby suppressing the generation of the blowholes and the pits at the welded portion.

The present invention is a welding method of metal members, in which first and second metal members which are made of a galvanized steel sheet, respectively, and positioned adjacent to each other are welded by arc welding, the welding method comprising a first step of bending adjacent portions of the first and second metal members in the same direction and forming a flange overlapping part where respective flange portions of the first and second metal members are overlapped and contact each other, a second step of starting to perform arc welding from a tip of the flange overlapping part, and a third step of continuing to perform the arc welding until molten metal of a core wire and a base material reaches an opposite-side face of the flange overlapping part and zinc gas generated is emitted from a side opposite to an arc-welding performance side of the flange overlapping part.

According to the present welding method of the metal members, the flange overlapping part where the flange portions of the first and second metal members contact each other is formed by bending the adjacent portions of the first and second metal members in the same direction in the first step, performing of the arc welding is started from the tip of the flange overlapping part in the second step, and in the subsequent third step, performing of the arc welding is continued until the molten metal of the core wire and the base material reaches the opposite-side face of the flange overlapping part and the zinc gas generated is emitted from the side opposite to the arc-welding performance side of the flange overlapping part.

Thereby, since the zinc gas generated during the welding is emitted from the side opposite to the arc-welding performance side, it can be properly prevented that the zinc gas stays inside the molten metal of the core wire and the base material (steel sheet), thereby suppressing the generation of the blowholes and the pits at the welded portion, without using any unique wire or any special arc-welding device.

An another aspect of the present invention is a welding structure of metal members, in which first and second metal members which are made of a galvanized steel sheet, respectively, and positioned adjacent to each other are welded by arc welding, the welding structure comprising a flange overlapping part where respective flange portions of the first and second metal members, which are made by bending adjacent portions of the first and second metal members in the same direction, are overlapped and contact each other, wherein arc welding is performed from a tip of the flange overlapping part, and a length of the flange overlapping part is set such that molten metal of a core wire and a base material reaches an opposite-side face of the flange overlapping part and zinc gas generated during the arc welding is emitted from a side opposite to an arc-welding performance side of the flange overlapping part before performing of the arc welding is complete.

According to the present welding structure of the metal members, since the length of the flange overlapping part is set such that the molten metal of the core wire and the base material reaches the opposite-side face of the flange overlapping part and the zinc gas generated during the arc welding is emitted from the side opposite to the arc-welding performance side of the flange overlapping part before performing of the arc welding is complete, the zinc gas generated during the arc welding can be emitted from the side opposite to the arc-welding performance side of the flange overlapping part. Accordingly, it can be properly prevented that the zinc gas stays inside the molten metal of the core wire and the base material (steel sheet), thereby suppressing the generation of the blowholes and the pits at the welded portion, without using any unique wire or any special arc-welding device.

In an embodiment of the above-described welding structure of the metal members, the thickness of the first and second metal members are 0.5 mm or greater and 2.6 mm or smaller, respectively, and the width of the flange overlapping part after the arc welding has been performed is 6.0-13.0 mm. The above-described width of the flange overlapping part after the arc welding has been performed corresponds to a width of a reinforcement of weld (a welded-metal portion which is raised from a surface of the base material).

According to this embodiment, the zinc gas generated during the welding can be more properly emitted, thereby suppressing the generation of the blowholes and the pits at the welded portion more surely.

In another embodiment of the above-described welding structure of the metal members, the thickness of the first and second metal members are 0.5 mm or greater and 2.6 mm or smaller, respectively, and the height of the flange overlapping part after the arc welding has been performed is 1.0-3.0 mm. The above-described height of the flange overlapping part after the arc welding has been performed corresponds to a height of the above-described reinforcement of weld.

According to this embodiment, the zinc gas generated during the welding can be more properly emitted, thereby suppressing the generation of the blowholes and the pits at the welded portion more surely. Further, since the above-described height of 1.0-3.0 mm means that the amount of protrusion from the metal members is so small, the present welding structure can be preferably applied to vehicle components or the like. That is, even if there exit other components around the present welding structure, the present welding structure does not require any large space to avoid interference with the other components surrounding the present welding structure, thereby improving the layout performance as well.

Further another aspect of the present invention is a welding structure of metal members, in which first and second metal members which are made of a galvanized steel sheet, respectively, and positioned adjacent to each other are welded by arc welding, the welding structure comprising a flange overlapping part where respective flange portions of the first and second metal members, which are made by bending adjacent portions of the first and second metal members in the same direction, are overlapped and contact each other, wherein arc welding is performed from a tip of the flange overlapping part, and a weld molten portion reaches an opposite-side face of the flange overlapping part such that zinc gas generated during the arc welding is emitted from a side opposite to an arc-welding performance side of the flange overlapping part.

According to this aspect of the present welding structure of the metal members, since the above-described weld molten portion (penetration) reaches the opposite-side face of the flange overlapping part such that the zinc gas generated during the arc welding is emitted from the side opposite to the arc-welding performance side of the flange overlapping part, the zinc gas generated during the arc welding can be emitted. Accordingly, it can be properly prevented that the zinc gas stays inside the molten metal including the weld molten portion, thereby suppressing the generation of the blowholes and the pits at the welded portion.

Other features, aspects, and advantages of the present invention will become apparent from the following description which refers to the accompanying drawings.

### BRIEF DESCRIPTION OF THE DRAWINGS

FIG. 1 is a sectional view showing a state of a welding method and a welding structure of the present invention before an arc welding is performed.

FIG. 2A is a sectional view showing part of FIG. 1, FIG. 2B is a sectional view showing the state at an initial stage of the arc welding, FIG. 2C is a sectional view showing the state at a middle stage of the arc welding, and FIG. 2D is a sectional view showing the state at a complete stage of the arc welding.

FIG. 3 is a major-part enlarged view of FIG. 2D.

FIG. 4 is a sectional view showing a conventional welding structure.

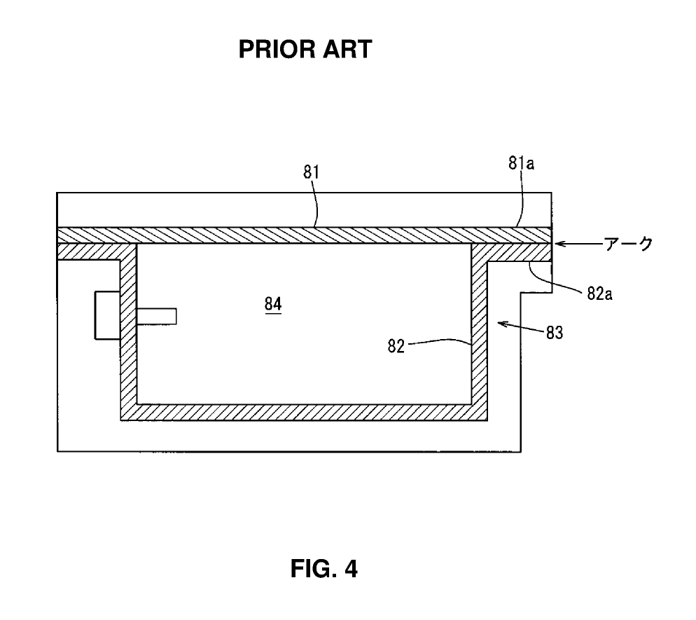

FIG. 5 is a sectional view showing another example of the conventional welding structure.

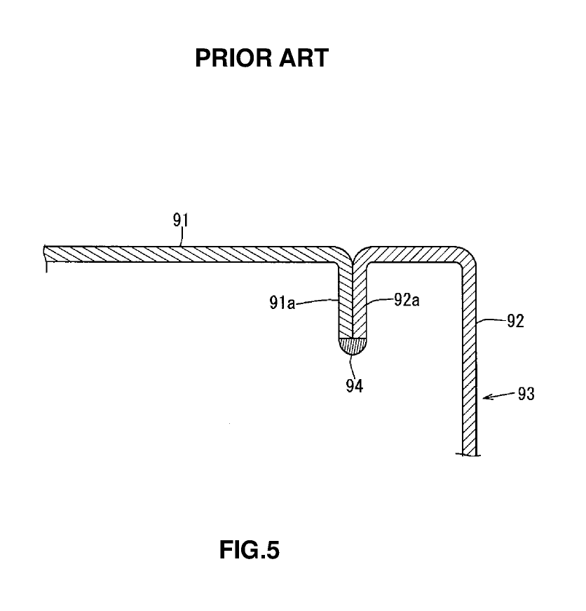

### DETAILED DESCRIPTION OF THE INVENTION

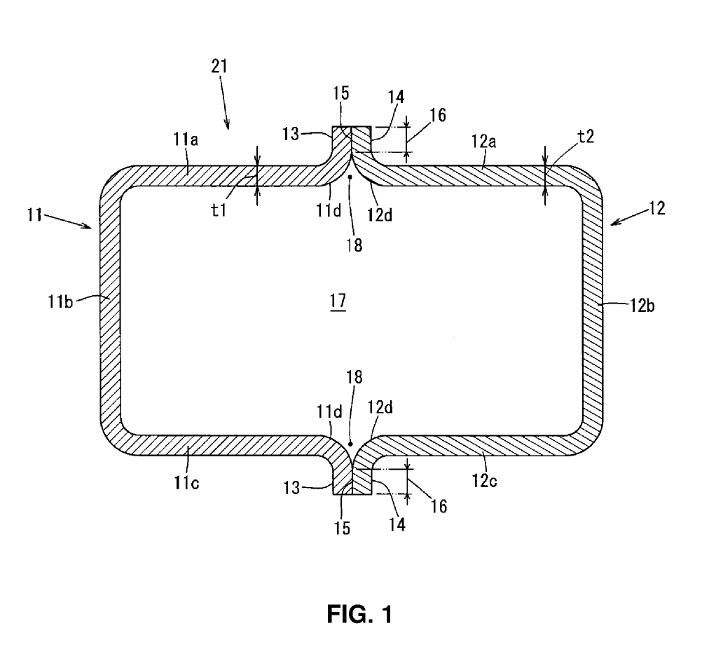

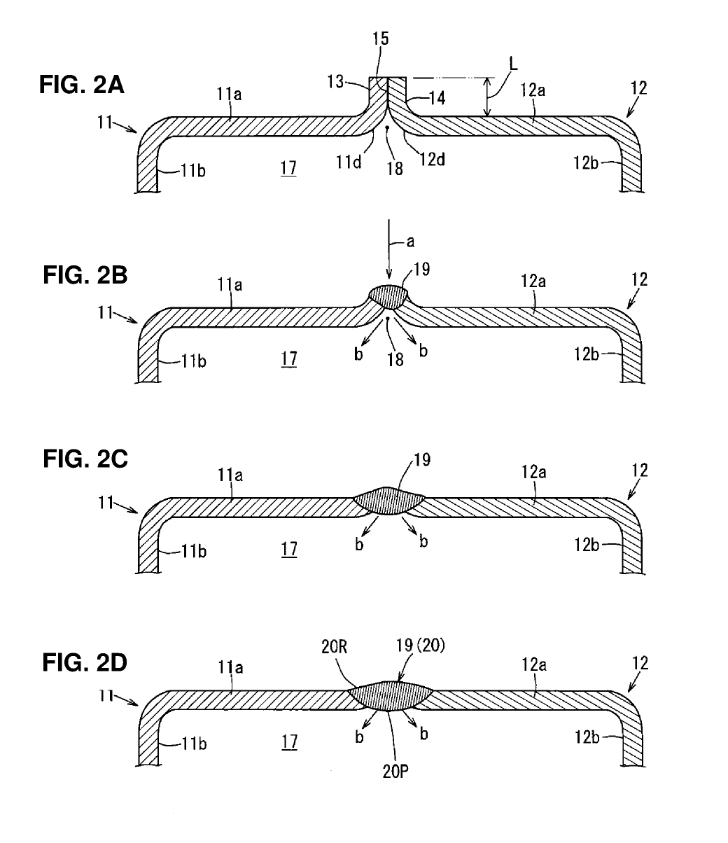

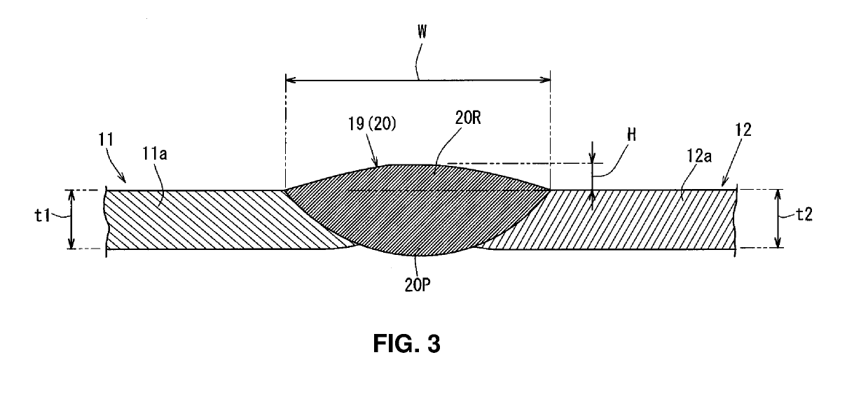

Hereafter, an embodiment of the present invention will be described specifically referring to the accompanying drawings. The drawings show a welding method and a welding structure of metal members, and FIG. 1 is a sectional view showing a state of the welding method and the welding structure of the present invention before an arc welding is performed, FIG. 2A is a sectional view showing part of FIG. 1, FIG. 2B is a sectional view showing the state at an initial stage of the arc welding, FIG. 2C is a sectional view showing the state at a middle stage of the arc welding, FIG. 2D is a sectional view showing the state at a complete stage of the arc welding, and FIG. 3 is a major-part enlarged view of FIG. 2D.

In FIG. 1, there are provided a first metal member 11 and a second metal member 12. These metal members 11, 12 are made of a galvanized steel sheet, respectively, which is formed by galvanizing a steel sheet (specifically, a soft steel sheet) for the purpose of rust prevention. Each plate thickness t1, t2 of these members 11, 12 is set at 0.5-2.6 mm.

The first metal member 11 is configured in an inclined U shape, which is integrally formed by an upper-side part 11a, a side part 11b, and a lower-side part 11c. The second metal member 12 is configured in an inversely-inclined U shape, which is integrally formed by an upper-side part 12a, a side part 12b, and a lower-side part 12c.

Respective adjacent portions of the first metal member 11 and the second metal member 12, that is—both end portions of their upper-side portions 11a, 12a and both end portions of their lower-side portions 11c, 12c are respectively bent in the same direction, i.e., toward an outside, via curved portions 11d, 12d (curvature-shaped portion), thereby forming respective flange portions 13, 14 and also a flange overlapping portion 15 where these flange portions 13, 14 contact each other (the first step).

Herein, since each of the respective flange portions 13, 14 includes a flat face portion 16, a contact structure of the flange portions 13, 14 is not a simple contact, but a face contact. Further, the both metal members 11, 12 have a closed cross section 17, respectively, by providing the flange overlapping portion 15 in a manner described above. Moreover, respective triangular space portions 18, 18 which are continuous to the closed cross section 17 are formed by the above-described pair of curved portions 11d, 12d.

After the both metal members 11, 12 are set as shown in FIGS. 1 and 2A, it is started to perform arc welding from a tip of the flange portion 15 as shown in FIGS. 2A and 2B (the second step).

In this case, an arc is produced along an arrow direction a (an arc-generation direction) shown in FIG. 2B between the galvanized steel sheet as a base material and a wire (not illustrated) as a core wire (filler material), and this arc producing is continued uniformly by moving the wire, thereby performing the arc welding. Specifically, the base material is provided as one of electrodes and the core wire is provided as the other electrode, and the arc is produced. An arc heat generated by this arc producing makes the flange overlapping portion 15 and the core wire melt, thereby performing the arc welding.

The welding method of the metal members of the present embodiment is executed by melting the flange portions 13, 14 sequentially as shown in FIGS. 2B, 2C and 2D. Herein, a boiling point of the zinc of the galvanized steel sheet is 906° C., and a melting point of the steel sheet of the base material is 1539±3° C. Since the boiling point of the zinc is lower than the melting point of the steel sheet, the zinc evaporates before the base material melts and the zinc gas is generated accordingly.

Therefore, as shown in FIGS. 2C and 2D, the arc welding is performed until molten metal 19 of the wire as the core wire and the galvanized steel sheet (see the flange portions 13, 14) as the base material reaches an opposite-side face (a face on the side of the closed cross section 17) of the flange overlapping part 15 and the zinc gas generated (see an arrow b of FIGS. 2B-2D) is emitted from a side opposite to an arc-welding performance side (see the arrow a of FIG. 2B) of the flange overlapping part (the third step).

Herein, since the triangular space 18 is formed by the above-escribed facing curved portions 11d, 12d, the emission of the zinc gas can be promoted from an initial stage to a middle stage of the arc welding shown in FIGS. 2B and 2C. The above-described molten metal 19 becomes a welded portion 20 including a weld molten portion (penetration) 20P and a reinforcement of weld 20R as shown in FIGS. 2D and 3 after it has solidified, so that the first metal member 11 and the second metal member 12 are fixedly joined together surely.

While only the arc welding of the upper-side flange overlapping portion 15 shown in FIG. 1 was explained in FIGS. 2A-2D, the arc welding is performed for the lower-side flange overlapping portion 15 shown in FIG. 1 similarly, thereby forming a closed cross-section structure 21 (see FIG. 1). Herein, the above-described welded portion 20 is continuously formed along a longitudinal direction of the closed cross-section structure 21, of course.

As shown in FIG. 2A, a length L of the flange overlapping portion 15 is set such that the molten metal 19 of the wire as the core wire and the base material reaches the opposite-side face of the flange overlapping part 15 and the zinc gas generated during the arc welding is emitted from the side opposite to the arc-welding performance side (the side of the arrow a) of the flange overlapping part 15 before performing of the arc welding is complete (see FIG. 2D). Thus, it is properly prevented that the zinc gas stays inside the molten metal 19, so that generation of the blowholes and the pits at the welded portion 20 is suppressed.

Further, as shown in FIG. 3, a width W of the flange overlapping portion 15, specifically the width W of the reinforcement of weld 20R (a welded-metal portion which is raised from a surface of the base material) after completion of the arc welding is set at 6.0-13.0 mm. Thereby, the zinc gas generated during the welding is more properly emitted, so that the generation of the blowholes and the pits at the welded portion 20 is suppressed more surely.

Moreover, as shown in FIG. 3, a height H of the flange overlapping portion 15, specifically the height H of the reinforcement of weld 20R after the completion of the arc welding is set at 1.0-3.0 mm. Thereby, the zinc gas generated during the welding is more properly emitted, so that the generation of the blowholes and the pits at the welded portion 20 is suppressed more surely.

As described above, the welding method of the metal members of the present embodiment, in which the first and second metal members 11, 12 made of the galvanized steel sheet, respectively, and positioned adjacent to each other are welded by the arc welding, comprises the first step (see FIG. 2A) of bending the adjacent portions of the first and second metal members 11, 12 in the same direction and forming the flange overlapping part 15 where the respective flange portions 13, 14 of the first and second metal members 11, 12 are overlapped and contact each other, the second step (see FIGS. 2A and 2B) of starting to perform the arc welding from the tip of the flange overlapping part 15, and the third step (see FIGS. 2C and 2D) of continuing to perform the arc welding until the molten metal 19 of the core wire and the base material (see the metal members 11, 12) reaches the opposite-side face of the flange overlapping part 15 and the zinc gas generated is emitted from the side opposite to the arc-welding performance side (see the arrow a direction of FIG. 2B) of the flange overlapping part 15 (see FIGS. 2A-2D).

According to the present welding method, the flange overlapping part 15 where the flange portions 13, 14 of the first and second metal members 11, 12 contact each other is formed by bending the adjacent portions of the first and second metal members 11, 12 in the same direction in the first step, performing of the arc welding is started from the tip of the flange overlapping part 15 in the second step, and in the subsequent third step, performing of the arc welding is continued until the molten metal 19 of the core wire and the base material reaches the opposite-side face of the flange overlapping part 15 and the zinc gas generated is emitted from the side opposite to the arc-welding performance side (the arrow a direction) of the flange overlapping part 15.

Thereby, since the zinc gas generated during the welding is emitted from the side opposite to the arc-welding performance side, it can be properly prevented that the zinc gas stays inside the molten metal 19 of the core wire and the base material (steel sheet), thereby suppressing the generation of the blowholes and the pits at the welded portion 20, without using any unique wire or any special arc-welding device.

Further, the welding structure of the metal members of the present embodiment, in which the first and second metal members 11, 12 made of the galvanized steel sheet, respectively, and positioned adjacent to each other are welded by the arc welding, comprises the flange overlapping part 15 where the respective flange portions 13, 14 of the first and second metal members 11, 12, which are made by bending the adjacent portions of the first and second metal members 11, 12 in the same direction, are overlapped and contact each other, wherein the arc welding is performed from the tip of the flange overlapping part 15, and the length L of the flange overlapping part 15 is set such that the molten metal 19 of the core wire and the base material reaches the opposite-side face of the flange overlapping part 15 and the zinc gas generated during the arc welding is emitted from the side opposite to the arc-welding performance side (see the arrow a direction of FIG. 2B) of the flange overlapping part before performing of the arc welding is complete (see FIGS. 2A-2D).

According to the present welding structure, since the length of the flange overlapping part 15 is set such that the molten metal 19 of the core wire and the base material reaches the opposite-side face of the flange overlapping part 15 and the zinc gas generated during the arc welding is emitted from the side opposite to the arc-welding performance side of the flange overlapping part 15 before performing of the arc welding is complete, the zinc gas generated during the arc welding can be emitted from the side opposite to the arc-welding performance side of the flange overlapping part 15. Accordingly, it can be properly prevented that the zinc gas stays inside the molten metal 19 of the core wire and the base material (steel sheet), thereby suppressing the generation of the blowholes and the pits at the welded portion 20, without using any unique wire or any special arc-welding device.

Moreover, the thickness t1, t2 of the first and second metal members 11, 12 are 0.5 mm or greater and 2.6 mm or smaller, respectively, and the width W of the flange overlapping part 15 after the arc welding has been performed is 6.0-13.0 mm (see FIG. 3). The above-described width of the flange overlapping part 15 after the arc welding has been performed corresponds to the width of the reinforcement of weld 20R (a welded-metal portion which is raised from a surface of the base material).

According to this structure, the zinc gas generated during the welding can be more properly emitted, thereby suppressing the generation of the blowholes and the pits at the welded portion 20 more surely.

Furthermore, the thickness t1, t2 of the first and second metal members 11, 12 are 0.5 mm or greater and 2.6 mm or smaller, respectively, and the height H of the flange overlapping part 15 after the arc welding has been performed is 1.0-3.0 mm (see FIG. 3). The height H of the flange overlapping part 15 after the arc welding has been performed corresponds to the height of the above-described reinforcement of weld 20.

According to this structure, the zinc gas generated during the welding can be more properly emitted, thereby suppressing the generation of the blowholes and the pits at the welded portion 20 more surely. Further, since the above-described height H of 1.0-3.0 mm means that the amount of protrusion from the metal members 11, 12 is so small, the present welding structure can be preferably applied to vehicle components or the like. That is, even if there exit other components around the present welding structure, the present welding structure does not require a large space to avoid interference with the other components surrounding the present welding structure, thereby improving the layout performance as well.

Further, the welding structure of the metal members of the present embodiment, in which the first and second metal members 11, 12 made of the galvanized steel sheet, respectively, and positioned adjacent to each other are welded by the arc welding, comprises the flange overlapping part 15 where the respective flange portions 13, 14 of the first and second metal members 11, 12, which are made by bending the adjacent portions of the first and second metal members 11, 12 in the same direction, are overlapped and contact each other, wherein the arc welding is performed from the tip of the flange overlapping part 15, and the weld molten portion 20P (penetration) reaches the opposite-side face of the flange overlapping part 15 such that the zinc gas generated during the arc welding is emitted from the side opposite to the arc-welding performance side (see the arrow a of FIG. 2B) of the flange overlapping part 15 (see FIGS. 2A-2D and 3).

According to this structure, since the above-described weld molten portion (penetration) 20P reaches the opposite-side face of the flange overlapping part 15 such that the zinc gas generated during the arc welding is emitted from the side opposite to the arc-welding performance side of the flange overlapping part 15, the zinc gas generated during the arc welding can be emitted. Accordingly, it can be properly prevented that the zinc gas stays inside the molten metal 19 including the weld molten portion 20P, thereby suppressing the generation of the blowholes and the pits at the welded portion 20.

Herein, while the above-described embodiment exemplified the closed cross-section structure 21 which is configured to have right-and-left two split structure and be substantially laterally-symmetrical as shown in FIG. 1, this structure may be configured to have right-and-left two split structure and be laterally asymmetrical, to have upper-and-lower two split structure and be substantially vertically-symmetrical, or to have upper-and-lower two split structure and be vertically asymmetrical.

Also, the present invention is not to be limited to the closed cross-section structure, but widely applicable to vehicle components, such as a suspension cross member, a lower arm, an upper arm, or a damper, home electric appliances, such as an air-conditioner case, or building materials.

Additionally, the above-described flange portion may be configured to extend straightly or roughly straightly along the longitudinal direction of the metal member, or to extend outward and in a ring shape from an end portion of a pipe-shaped metal member or a bowl-shaped metal member.

What is claimed is:

1. A welding method of metal members, in which first and second metal members which are made of a galvanized steel sheet, respectively, and positioned adjacent to each other are welded by arc welding, the welding method comprising:
a first step of bending adjacent portions of the first and second metal members in the same direction and forming a flange overlapping part where respective flange portions of the first and second metal members are overlapped and contact each other;
a second step of starting to perform arc welding from a tip of the flange overlapping part; and
a third step of continuing to perform the arc welding until molten metal of a core wire and a base material reaches an opposite-side face of the flange overlapping part and zinc gas generated is emitted from a side opposite to an arc-welding performance side of the flange overlapping part.

2. A welding structure of metal members, in which first and second metal members which are made of a galvanized steel sheet, respectively, and positioned adjacent to each other are welded by arc welding, the welding structure comprising:
a flange overlapping part where respective flange portions of the first and second metal members, which are made by bending adjacent portions of the first and second metal members in the same direction, are overlapped and contact each other,
wherein arc welding is performed from a tip of said flange overlapping part, and a length of the flange overlapping part is set such that molten metal of a core wire and a base material reaches an opposite-side face of the flange overlapping part and zinc gas generated during the arc welding is emitted from a side opposite to an arc-welding performance side of the flange overlapping part before performing of the arc welding is complete.

3. The welding structure of the metal members of claim 2, wherein the thickness of the first and second metal members are 0.5 mm or greater and 2.6 mm or smaller, respectively, and the width of said flange overlapping part after the arc welding has been performed is 6.0-13.0 mm.

4. The welding structure of the metal members of claim 2, wherein the thickness of the first and second metal members are 0.5 mm or greater and 2.6 mm or smaller, respectively, and the height of said flange overlapping part after the arc welding has been performed is 1.0-3.0 mm.

5. A welding structure of metal members, in which first and second metal members which are made of a galvanized steel sheet, respectively, and positioned adjacent to each other are welded by arc welding, the welding structure comprising:
a flange overlapping part where respective flange portions of the first and second metal members, which are made by bending adjacent portions of the first and second metal members in the same direction, are overlapped and contact each other,
wherein arc welding is performed from a tip of said flange overlapping part, and a weld molten portion reaches an opposite-side face of the flange overlapping part such that zinc gas generated during the arc welding is emitted from a side opposite to an arc-welding performance side of the flange overlapping part.

6. The welding structure of the metal members of claim 5, wherein the thickness of the first and second metal members are 0.5 mm or greater and 2.6 mm or smaller, respectively, and the width of said flange overlapping part after the arc welding has been performed is 6.0-13.0 mm.

7. The welding structure of the metal members of claim 5, wherein the thickness of the first and second metal members are 0.5 mm or greater and 2.6 mm or smaller, respectively, and the height of said flange overlapping part after the arc welding has been is 1.0-3.0 mm.
